(19) United States
(12) Patent Application Publication
(10) Pub. No.: US 2012/0205319 A1
(43) Pub. Date: Aug. 16, 2012

(54) Apparatus and Method for Discharge of Treated Sewage Sludge from Bins

(75) Inventors: Richard W. Christy, Eagleville, PA (US); Michael Quici, Ambler, PA (US); David M. Van Bramer, Bristol, PA (US)

(73) Assignee: RDP TECHNOLOGIES, INC., Norristown, PA (US)

(21) Appl. No.: 13/027,506

(22) Filed: Feb. 15, 2011

(51) Int. Cl. C02F 1/56; C02F 11/18; C02F 11/00

(52) U.S. Cl. 210/737; 210/187; 210/141

(57) ABSTRACT

Treated sewage sludge containing a flocculant is discharged from bottom of a bin, with the discharge being facilitated by heating sloped walls of the bin an amount sufficient to increase the ability of the sludge to slide along sloped bin walls. The flocculant in the sludge includes a polymeric material which, when heated to a sufficient temperature effects a phase separation of the polymeric material from water, decreasing the viscosity of the polymeric material, facilitating its sliding along the sloped walls. The heating of the polymeric material in the flocculant enables the sloped walls of the bin to be flatter than they would otherwise be, allowing an enhanced volume of sludge to be present in the bin. A programmable logic computer controls the provision of heat to the sloped walls, as well as controlling an openable closure at the bottom of the bin and/or controlling the rotation of a displacement device in the bin.

### BACKGROUND OF THE INVENTION

The present invention is directed to a method and apparatus for the automated discharge of treated sewage sludge from bins, as part of a sludge handling system.

In the treatment of sewage sludge so that it can meet the various criteria of the U.S. Environmental Protection Agency, so that the sewage sludge can be returned to the earth as fertilizer, or in some cases be used as ground fill, it has become commonplace that the sludge is first treated to remove pathogens, or at least reduce the pathogens in the sludge to an EPA acceptable level and to reduce the attractiveness of the sludge to vectors such as rats, mice, flies, etc., as well as to reduce the odors that may otherwise emanate from the sludge. The sludge generally has both solid and liquid components. Often, the sludge is dewatered to produce a higher solids content. The solids content of the sludge can vary, such that the physical characteristics of the sludge can range from a viscous, colloidal liquid to a dry cake or clay-like texture.

Some of the methods and apparatus for treating sludge, to which the present invention is addressed include the following patents, all of which are herein incorporated by reference:

| | |
|---|---|
| 5,013,458 | 5,186,840 |
| 5,229,011 | 5,346,616 |
| 5,401,402 | 5,405,536 |
| 5,433,844 | 5,554,279 |
| 5,618,442 | 5,681,481 |
| 5,783,073 | 5,851,404 |
| 7,669,348 | 7,416,673 |

In accordance with the present invention, dewatered sludge is delivered to a conveyor device that can be any of various types, such as a belt conveyor, a screw conveyor, a pump for pumping sludge through a duct or tube, or any other conveyor devices that supplies sludge to a gravity flow bin. Preferably, a plurality of conveying devices are used, each supplying sludge to a different gravity flow bin. One such apparatus for delivering dewatered sludge to a conveyor mechanism for, in turn, delivering sludge to one or more gravity flow bins, is disclosed in U.S. Pat. No. 6,447,674, the complete disclosure of which is herein incorporated by reference.

Generally, dewatered biosolids (sludges) have, by their nature, a resistance to flow because water has been removed and flocculants, generally of polymeric material have been added to thicken the sludge by adsorbing onto sludge particles to aggregate the sludge particles. During the treatment of the sludge, calcium may be added to the sludge to reduce pathogens, and the polymeric material has also been added to the sludge in order to provide flocculation. By adding a flocculant, the sludge develops a consistency similar to that of clay, and then the sludge is squeezed to reach a semi-solid appearance, having about 20% solids, with the rest being water.

In some cases, simply opening a bottom gate of the flow bin is enough to initiate flow, as gravity takes over. In other cases, the resistance to flow and/or the wall friction exceeds the force of gravity, particularly when the quantity of sludge in the flow bin is reduced, thereby reducing the “head” of sludge in the bin. When gravity flow bins are fully loaded, there is a greater amount of “head”, facilitating the unloading of the bin when the bottom gate is opened. However, if the bin is only slightly full, the sludge may have formed as “cake”, perhaps having remained in the bin for a couple of days without any sludge having been removed from the bin in that period, or a rusting or other surface phenomenon on the inner walls of the bin may have occurred, presenting a resistance to flow of sludge along sloped bin walls, and gravity flow may not as easily occur, leaving the sludge adhered to bin walls.

### The Present Invention

In accordance with this invention, one feature of the flow bins is that they are constructed to allow for mass flow, such that when a bottom gate of the bin is opened, flow initially proceeds on a first in-first out basis that is steady and controlled, reducing the opportunity for portions of the sludge in the bin to become stagnant that could lead to re-growth of bacteria, viruses, etc., resulting also in production of undesirable odor.

The present invention is addressed to facilitating the movement of sewage sludge along sloped walls of a bin, toward a bottom discharge opening by heating at least portions of the sludge that are disposed against the sloped walls an amount sufficient to increase the ability of the sludge to slide along the sloped portions of the bin side walls, wherein the heating increases the temperature of the flocculant that includes a polymeric material. The heating may take place through the sloped walls of the bin. The heating of the polymeric material component of the flocculant raises its temperature enough to effect a phase separation of the polymeric material components, liquefying the same, whereby water separates from the polymeric material component and the viscosity of the polymeric material component drops, enabling the treated sludge that contains the polymeric material component to slide downwardly along sloped portions of a bin, via gravity flow. The amount of heat applied is not enough to create a crust on the sloped wall portions, which would only increase the frictional resistance to sludge sliding along the sloped wall portions.

The heating of the polymeric material component may be done in conjunction with opening the bottom of the bin for discharge, and may be controlled by a programmable logic computer, with or without controlling the rotation of a displacement device near the bottom of the bin in conjunction with the heating of the bin side walls.

Accordingly, it is a primary object of this invention to heat sloped side walls of a bin of a sewage sludge handling system, in order to provide heat to liquify a flocculant in the sewage sludge, in an amount sufficient to increase the ability of the sludge to slide along sloped portions of the bin side walls.

It is another object of this invention to accomplish the above object, wherein the heating is done through the bin side walls.

It is a further object of this invention to accomplish the above objects, wherein the flocculant in the sewage sludge includes a polymeric material component, and heat is supplied in sufficient quantity to the polymeric material component so that a phase separation occurs between the polymeric material component and water present in the sludge, so that water separates from the polymeric material component and the viscosity of the polymeric material component of the sludge drops, facilitation sliding of the sludge along sloped portions of a bin.

It is a further object of this invention to accomplish the above objects, wherein a programmable logic computer is provided for coordinating the heating of the sewage sludge with one or both of controlling the operation of an openable closure for the bin and controlling the rotation of a displacement device inside of, but located near the bottom of the bin, in which the displacement device assists movement of the sludge out a discharge opening of the bin.

Further objects of this invention are the provision of equipment and processes for accomplishing the above objects.

Other objects and advantages may be readily apparent upon a reading of the following brief descriptions of the drawing figures, the detailed description of the preferred embodiments and the appended claims.

### SUMMARY OF THE INVENTION

The present invention is directed to a method and apparatus for facilitating the sliding of sewage sludge along a sloped portion of a bin of a sludge handling system, by heating at least portions of the sludge that are disposed against sloped portions of bin side walls an amount sufficient to increase the ability of the sludge to slide along the sloped portions of the side walls.

### BRIEF DESCRIPTIONS OF THE DRAWING FIGURES

FIG. 1 is a schematic illustration of a sludge handling system, in which treated sludge, comprising sewage sludge, a treatment medium, and a flocculant is delivered to a plurality of bins via conveyor devices, and in which discharge of sewage sludge from bottom portions of bins, wherein the bins have sloped side walls, with the delivery of sewage sludge to a truck beneath the bins is illustrated, and wherein the bins are heated for delivering heat to the flocculant within the bin side walls.

FIG. 2 is a schematic illustration of a prior art type of bin from a system like FIG. 1, having sloped side walls, a displacement arm for assisting the removal of sludge through a bottom opening, and an openable closure for the bottom opening of the bin, with an optional conical structure disposed in the bin.

FIG. 3 is a schematic illustration like that of FIG. 2, but of the bin as modified in accordance with the present invention, to have heated wall portions pursuant to this invention, enabling flatter sloped wall portions to increase bin capacity, and wherein the opening and closing of the bin discharge opening and the rotatable displacement arm are controlled by a programmable logic computer, as is the heating of wall portions of the bin.

FIG. 4 is a fragmentary schematic illustration of a portion of a sloped bin wall in accordance with FIG. 3, wherein an alternative heating arrangement is used for heating the bin side wall.

### DETAILED DESCRIPTION OF THE PREFERRED EMBODIMENTS

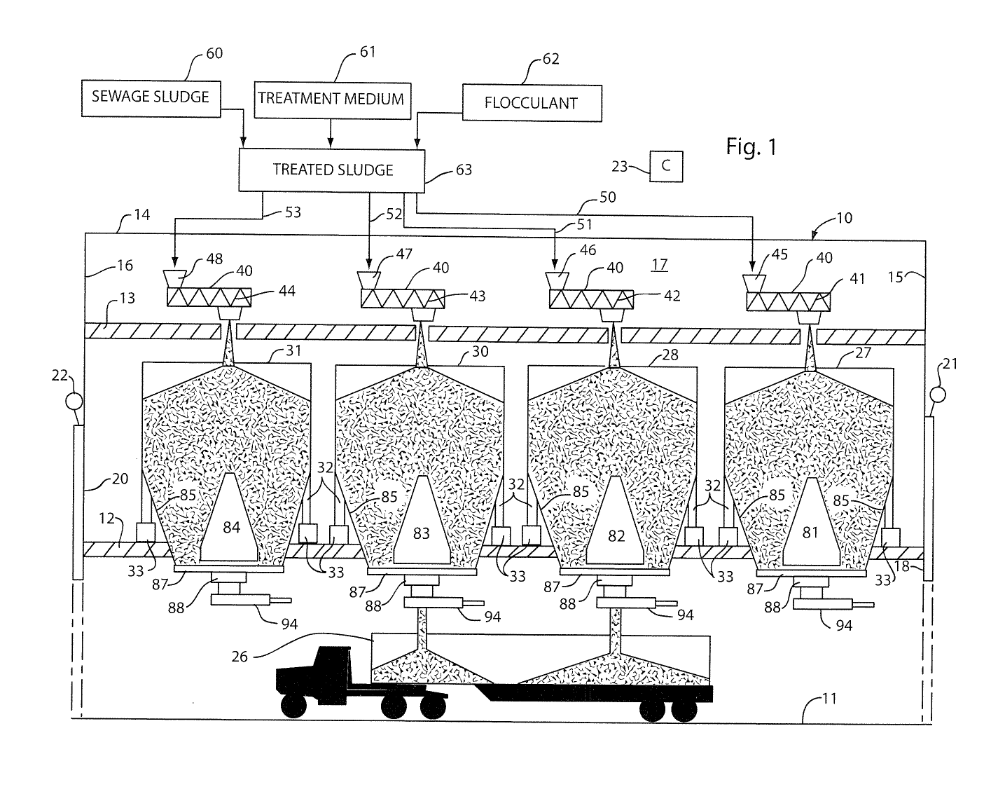

Referring now to the drawings in detail, reference is first made to FIG. 1, in which a garage, warehouse or similar structure 10 is illustrated, having a ground level floor 11, a higher floor 12, an even higher floor 13, a roof 14, right and left end walls 15 and 16, respectively, a near wall (not shown) and a far wall 17.

Right and left openable doors 18, 20 are located in end walls 15, 16, respectively, shown in full lines in the open position, with lower ends thereof being shown in phantom position, as closed doors. The doors 18, 20 each have motorized opener mechanisms 21, 22, respectively. It will be understood that the opening and closing of the doors 18, 20 are to permit entry and exit of a truck 26, driven into the garage 10.

Between the floors 12, 13 of the garage 10, there are a plurality of storage bins 27, 28, 30 and 31. In FIG. 1, there are four storage bins illustrated, although it will be understood that in the system disclosed herein, there could be a fewer number of bins, or a greater number of bins, as the operator of the facility may desire.

Each of the bins 27, 28, 30, 31 is supported on a plurality of generally vertically disposed support legs 32, that, in turn, are supported on load cells 33. The load cells are weight-responsive and are mounted on the floor 12 and are electrically connected to a computer 23 via suitable control lines, not shown.

The load cells may be constructed as are the load cells in U.S. Pat. No. 7,669,348, or any one or more of U.S. Pat. Nos. 5,770,823; 4,064,744; 4,166,997; 4,454,770 and 5,313,022, the complete disclosures of which are herein incorporated by reference.

The load cells 33 provide the computer 23 with information as to the weight of the bin with which the load cells are associated, together with the weight of the biosolids or sludge in that associated bin. Because the weight of the bin itself is a known, predetermined quantity, and because the computer 23 is programmed to subtract the weight of the bin with which any group of associated load cells is associated, the computer can readily determine the weight of the biosolids or sludge in that particular bin, with which that group of load cells is associated.

Above the upper floor 13 of the garage 10, there are located a plurality of conveyors 40, each having a preferably helical screw auger 41, 42, 43 or 44 respectively therein, as illustrated in FIG. 1, or, alternatively pumps with associated conduits (not shown) for conveying biosolids sludge that has previously been delivered to the conveyor devices from a dewatering device (not shown) that, in turn, either continuously or periodically delivers dewatered sludge to opening 45, 46, 47 or 48 of the conveyor device via lines 50, 51, 52 and 53.

At the upper end of FIG. 1, it is seen that it is shown schematically that sewage sludge 60, a treatment medium 61, and a flocculant 62 are combined as treated sludge 63, that, as described above, is delivered to the conveyors 40 that supply the bins 27, 28, 30 and 31.

The treatment medium 61 may comprise a lime stabilization that includes the addition of an alkaline substance such as calcium oxide, calcium carbonate and/or compounds such as quicklime, lime kiln dust, cement kiln dust or dolomitic lime.

The flocculant 62 may include a polymeric material component that facilitates flocculation or floccing up suspended and treated sewage sludge in a liquid, to produce a thickening or clumping of the treated sewage sludge, to have a consistency somewhere like that of cottage cheese. The thus treated sludge with a flocculant will still contain substantial amounts of water, in that the solids component thereof will ordinarily be on the order of 20%, with the remaining 80% being water.

The mixing of the flocculant that includes a polymeric material component with the treated sludge, as illustrated in FIG. 1 causes an aggregation of sludge particles by portions of a polymer chain in the sludge being adsorbed on components of the sludge.

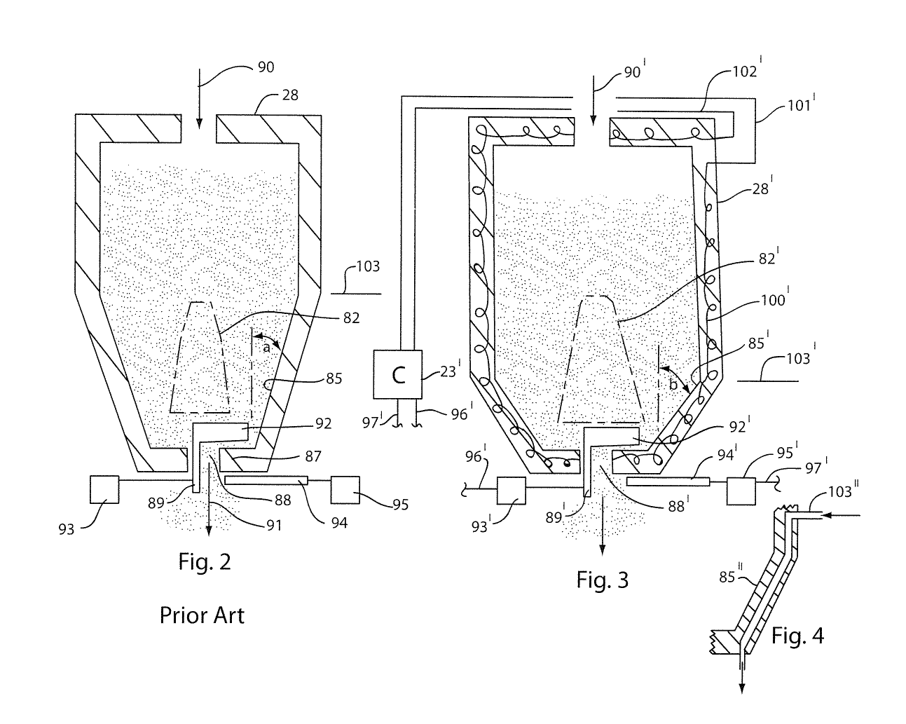

With reference to FIG. 2, in which a representative bin 28 is provided, of a prior art type, having an inlet of treated sludge thereto via inlet line 90, and sloped side walls 85, and a bottom 87 and central discharge 88, with an optional conical structure 82, it is seen that treated sludge may be discharged through the bottom opening 88 via discharge line 91. A displacement arm 92 may be provided, shaft-mounted at 89 and shaft-driven via a motor 93, which motor 93 may be a variable speed motor, as may be desired, with the displacement arm 92 facilitating the discharge of sewage sludge out the discharge opening 88. In FIG. 2, the optional conical structure 82, as described above, is illustrated in broken lines, as an option to the FIG. 1 and FIG. 2 arrangements.

The positive displacement reclaim arm 92 is adapted to sweep sludge that is at the bottom of the bin, across its floor 87, to discharge at location 88. The aim 92 is optionally provided, in that in many instances, the discharge of biosolids sludge from a bin may occur by means of mass flow; i.e. gravity only, not requiring the use of a displacement reclaim arm 92. In other instances, the use of an arm 92 will be desirable and very effective. Other types of rotating arms or other mechanisms may alternatively be used to facilitate discharge of sludge from the bottom of a bin. The use of such an arm facilitates controlling the rate of discharge and thereby enables the discharge of sewage sludge on a first-in/first-out basis, to avoid an increase in pathogens that might otherwise take place, in order to have odor control, and so that the sludge will continue to meet Class B treatment in accordance with E.P.A. standards, which will prevent pathogen regrowth.

Each of the bins 27, 28, 30, 31 is preferably generally cylindrical in construction, having tapered lower wall portions 85, although, if desired, at least the upper ends of the bins could be of rectangular or other construction, as may be desired. While, ideally the bins would have vertically straight sidewalls for free mass flow, the tapered lower wall portions 85 of the bins of FIG. 2 may be at a first predetermined steep acute angle “a” to the vertical of its associated bin, in order to facilitate flow of biosolids sludge out of the bin, through the bottom thereof.

In the bins there are, optionally, fixably mounted conical structures or cones 81, 82, 83 and 84 to eliminate or minimize funnel flow carried from bin walls 85 via mounting struts, (not illustrated for the sake of clarity). The conical structures facilitate the breaking up of biosolids sludge as such sludge travels through the bin, from the upper end, to a discharge location at a lower end thereof. Such conical structures 81-84 also preclude the formation of a dome of sludge within a bin, and shield the weight of sludge in the bin from moving parts such as a discharge arm or other moving mechanism.

The bins 27, 28, 30, 31 are each provided with bottom floors 87, each having a central discharge location 88 at the geometric center thereof. The discharge locations 88 are beneath the conical structures 81-84 in each of the bins.

Each of the bins 27, 28, 30, 31 will have its discharge opening 88 opened, closed, or partially open, by means of a slide gate sealing system 94 controlled via associated motorized or air (pneumatic) or hydraulic actuators (not illustrated) that are computer controlled from the computer 23, via electrical or other control lines (not shown), which the computer will control.

The slide gate sealing systems 94 that control the opening, closing and speed of opening and closing of the discharge openings 88 may be constructed in accordance with U.S. Pat. No. 6,698,766, the complete disclosure of which is herein incorporated by reference, or by any other suitable slide gate for discharging sludge that can have its operation controlled.

The slide gate sealing systems 94 may be operated via suitable motors 95.

With reference now to FIG. 3, there is illustrated in detail the structure that enables the heating of sludge in accordance with this invention, so that the polymeric component of the flocculant in the sludge enables the sludge adjacent the sloped wall portions 85′ of the bin 28′ to slide therealong, facilitating the discharge of the sludge outwardly of the discharge opening 88′. At the upper end of the bin 28′, there is provided an inlet arrow 90′ indicating that treated sewage sludge enters the bin 28′, and accumulates in the bin, as shown. A positive displacement reclaim arm 92′ is provided, shaft-mounted at 89′, and controlled via a motor 93′ that is controlled via the programmable logic computer 23′ via control line 96′.

In FIG. 3, the slide gate sealing system 94′ is provided, as described above with respect to the slide gate sealing system 94, except that the motor 95′ is also controlled via the programmable logic computer 23′ via control line 97′.

Associated with the walls of the bin 28′, and most specifically especially the sloped wall portions 85′ thereof, there is provided a heating means 100′, in the form of electric heating element(s), whereby electrical energy supplied thereto for heating the sloped wall portions 85′ is controlled via control lines 101′, 102′ that, in turn, are controlled via the programmable logic computer 23′.

The electric heating element(s) 100′ can thus be controlled by the programmable logic computer 23′, either continuously, or in conjunction with the opening of the discharge opening 88′, by controlling the motor 95′ that operates the slide gate sealing system 94′.

Additionally, the operation of the displacement arm 92′ for assisting the discharge of sewage sludge through the discharge opening 88′ may likewise, if desired, be controlled to operate at the same time as the programmable logic computer 23′ controls the electric heating element(s) 100′, in that the programmable logic computer 23′ can control the operation of the motor 93′ that controls the rotation of the displacement arm 92′.

The heating element(s) 100′ may, if desired, be inside the side wall(s) of the bin 28′, as shown, or outside thereof, so long as there is provided sufficient heat to raise the temperature of the polymeric material component of the sludge, liquefying the same, to increase the ability of the polymeric material component of the sludge to slide along the sloped side wall portions 85′ of the bin side wall(s), via gravity flow.

The mixing of the treated sludge with a flocculant that includes a polymeric material component, coupled with the heating of the polymeric material component in the bin 28′ an amount sufficient to effect a phase separation of the polymeric material component so that water separates from the polymeric material component, decreasing the viscosity of the polymeric material component, enables the treated sludge to slide downwardly along the sloped wall portions 85′ of the bin 28′.

The temperature at which the sloped side wall portions 85′ of the bin will provide sufficient heat to heat the polymeric material component of the sludge that is adjacent the sloped side wall portions 85′ should be high enough to liquefy the polymeric material component of the sludge, but not enough to create a crust on the sloped wall portions.

With reference to FIG. 4, a sloped side wall portion 85″ of a bin is fragmentally illustrated, in which an alternative mechanism is provided for providing heat to sludge in the bin. In the form of a duct 103″, for enabling the delivery of a fluid, such as a liquid or gas, in the form of for example, heated water or steam, or other fluid through at least side wall portions of a bin, for effecting the heating of sewage sludge in the bin, in the manner described above with respect to FIG. 3, but via an alternative heating technique.

In accordance with this invention, it will be noted, with reference to FIG. 3, that the vertical level 103′ of the upper end of the sloped portion 85′ of the bin is enabled to be at a lower level 103′ of the bin 28′ of FIG. 2, thereby allowing a flatter slope for sloped walls 85′, at a greater angle “b” to the vertical than the angle “a” of FIG. 2, to enable a substantial increase in the volume, and therefore the capacity of sewage sludge that can be retained in a bin 28′, in view of the flattening of the slope of the sloped portions of the side wall(s). This flattening of the slope of the sloped portions 85′ of FIG. 3, relative to sloped portions 85 of FIG. 2, when heat is applied via the heating element 100′ or 103″ can, in many instances, eliminate the need for a conical structure 82′ (shown in phantom in FIG. 3), and may also eliminate the need for using a rotatable displacement arm 92′, as described above, in facilitating a gravity flow of sewage sludge along the sloped side walls 85′.

It will be apparent from the foregoing the various modifications may be made in the apparatus described above, as well as in the use and operation of the same, including in the process steps, as may suggest themselves to those skilled in the art, upon a reading this specification, all within the spirit and scope of the present invention, as defined in the appended claims.

What is claimed is:

1. In a sludge handling system in which treated sewage sludge having a water component and containing a flocculant is delivered to at least one bin, and wherein the at least one bin has an inlet at an upper end for receiving the sludge therein, a bottom discharge opening for discharge of sludge therethrough and side wall(s), with at least portions of the side wall(s) being sloped toward the discharge opening, the at least one bin being provided with means for heating at least portions of the sludge that are disposed against the sloped portions of the side wall(s) an amount sufficient to increase the ability of the sludge to slide along the sloped portions of the side wall(s).

2. The system of claim 1, wherein the flocculant includes a polymeric material component and wherein the means for heating comprises a means for heating the polymeric material component an amount sufficient to increase the ability of the polymeric material component of the sludge to slide along the sloped portions of the sidewall(s).

3. The system of claim 1, wherein the means for heating includes at least one heating member carried by the at least one bin sidewall(s).

4. The system of claim 3, wherein the means for heating comprises at least one electric heating element.

5. The system of claim 3, wherein the means for heating comprises means for heating the at least one bin sidewall(s) via a heated fluid medium.

6. The system of claim 3, including an openable closure for said discharge opening, and a programmable logic computer for controlling said openable closure, and means connected to said programmable logic computer for activating said heating member in conjunction with the controlling of said openable closure.

7. The system of claim 3, including a rotatable displacement device at the lower end of said at least one bin for engaging sludge at the lower end of said at least one bin and assisting movement of the sludge out said discharge opening, and a programmable logic computer for controlling the rotation of said displacement device, and means connected to said programmable logic computer for activating said heating member in conjunction with the controlling of the rotation of said displacement device.

8. In a sludge handling system in which treated sludge having a water component and containing a flocculant is delivered to at least one bin, and wherein the at least one bin has an inlet at an upper end for receiving the sludge therein, a bottom discharge opening for discharge of sludge therethrough and sidewall(s), with at least portions of the sidewall(s) being sloped toward the discharge opening, the process of increasing the ability of the treated sludge to slide along the sloped portions of the at least one bin comprising:
(a) mixing the treated sludge with a flocculant that includes a polymeric material component; and
(b) heating the polymeric material component in the at least one bin an amount sufficient to effect a phase separation of the polymeric material component whereby water separates from the polymeric material component and the viscosity of the polymeric material component decreases, so that the treated sludge slides downwardly along the sloped portions of the at least one bin.

9. The process of claim 8, wherein step (a) includes aggregation of sludge particles by portions of a polymer chain in the slurry being adsorbed on components of the sludge.

10. The process of claim 8, wherein the heating of step (b) occurs at a temperature sufficient to liquefy the polymeric material component.

11. The process of claim 8, wherein an openable closure is provided for the discharge arm, including the step of controlling the opening of the closure through a programmable logic computer in conjunction with the heating of the polymeric material component in the at least one bin.

12. The process of claim 8, in which a rotatable displacement device is located at a lower end of the at least one bin, including the step of controlling the heating of the polymeric material component in conjunction with controlling the rotation of the rotatable displacement device through a programmable logic computer, so that the rotatable displacement device engages sludge at the lower end of the at least one bin and assists the movement of the sludge out a discharge opening in conjunction with the heating of the polymeric material component.

13. In a sludge handling system in which treated sewage sludge having a water component and containing a flocculant is delivered to at least one bin, and wherein the at least one bin has an inlet at an upper end for receiving the sludge therein, a bottom discharge opening for discharge of sludge therethrough and sidewall(s), with at least portions of the sidewall(s) being sloped toward the discharge opening, the process of increasing the volume of sewage sludge that can be retained in a bin of a predetermined cross-sectional size and height by flattening the slope of sloped portions of the sidewall(s) of the at least one bin an amount sufficient to allow sewage sludge to slide via gravity along sloped portions of the sidewall(s), by:
(a) providing a flocculant having a polymeric material component that is heat-responsive; and
(b) heating the polymeric material component in the at least one bin an amount sufficient to effect a phase separation of the polymeric material component, whereby water separates from the polymeric material component and the viscosity of the polymeric material component drops, so that the treated sludge slides downwardly along the sloped portions of the at least one bin, whereby the flattened sloped portions occupy a reduced vertical height in the at least one bin, allowing an enhanced volume of sludge in the bin above the sloped portions of the sidewall(s).

14. The process of claim 13, wherein the heating of step (b) occurs at a temperature sufficient to liquefy the polymeric material component.

15. The process of claim 13, wherein an openable closure is provided for the at least on bin, including the step of controlling the opening of the closure through a programmable logic computer in conjunction with the heating of the polymeric material component in the at least one bin.

16. The process of claim 13, in which a rotatable displacement device is located at a lower end of the at least one bin, including the step of controlling the heating of the polymeric material component in conjunction with controlling the rotation of the rotatable displacement device through a programmable logic computer, so that the rotatable displacement device engages sludge at the lower end of the at least one bin and assists the movement of the sludge out the discharge opening in conjunction with the heating of the polymeric material component.
